(19) United States
(12) Patent Application Publication
(10) Pub. No.: US 2026/0300126 A1
(43) Pub. Date: Oct. 1, 2026

(54) Industrial Automation Sequence of Operation (SoO) and Misuse Sequence of Operations (MSoO) for Mechanical and Process Systems

(71) Applicants: Jeffrey Allen Shearer, Prescott, AZ (US); Jason James Dely, Tillsonburg (CA); Timothy John Conway, Sandy, UT (US); Bryan Joseph Johns, Clayton, NC (US)

(72) Inventors: Jeffrey Allen Shearer, Prescott, AZ (US); Jason James Dely, Tillsonburg (CA); Timothy John Conway, Sandy, UT (US); Bryan Joseph Johns, Clayton, NC (US)

(21) Appl. No.: 19/093,479

(22) Filed: Mar. 28, 2025

(51) Int. Cl. G06F 11/3604

(52) U.S. Cl. CPC G06F 11/3608

(57) ABSTRACT

A system and method that enables mechanical, process or automation engineers to define and document the intended sequencing of physical devices found on mechanical and process systems. An embedded Sequence of Operations (SoO) software tool verifies that the Industrial Control System(s) (ICS) program has been written to meet the designers intended sequencing of the physical devices. This software tool also allows an engineer to define and document the Misuse Sequence of Operations (MSoO) in order to indicate which mechanical devices or process operations should not be operated simultaneously or in a certain sequence to avoid a misuse of physical devices or to create an undesirable process reaction. The software tool also allows the engineer to define and document the boundary conditions of the electrical or mechanical devices so the code verification software can ensure the devices are being operated within the intended parameters.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Industrial machinery is designed, built and installed into a factory or industrial plant environments in order to support the production of a physical product for a customer. Machines can be found in every facet of producing a product including but not limited to mining and gathering raw materials, transforming raw materials into something more usable in the production of a final product, part assembly, automated welding operations, mixing and heating of chemicals or ingredients, batching and warehousing of products. While the types of machines found in worldwide production are too numerous to list, the majority of these machines have mechanical systems that are controlled by Industrial Control System(s) (ICS). Without the ICS, the machinery would be incapable of controlling itself mechanically and therefore unable to produce the intended product for which the machine was designed.

ICS's are engineered and installed to manipulate physical control elements found on machinery such as but not limited to motors, linear actuators, solenoids, pressure and flow valves, indicator lights and many other physical entities found on machinery. These physical output devices are manipulated through the means of electrical signals sent from the ICS. These ICS's are also engineered to read electronic process inputs from sensors such as but not limited to temperature sensors, fluid and gas flow sensors, liquid level sensors, pressure sensors, and positional sensors. Even manual intervention input devices from an operator such as physical pushbuttons, Human Machine Interfaces (HMIs), Electronic Operator Interfaces (EOIs) and other input devices are wired directly to or networked into the ICS to receive feedback from the process being controlled.

These ICS's are commonly referred to and are commonly known as Programmable Logic Controllers (PLCs), Process Automation Controllers (PACs), Distributed Control Systems (DCS) and Supervisory Control and Data Acquisition (SCADA) systems. These systems are engineered to control physical devices that have been designed to work together to control complex mechanical systems and processes. These ICS's are commonly designed and programmed by an automation engineer, electrical engineer, maintenance staff or instrument and control technicians using an ICS vendor design tool(s) and not by the mechanical engineer that has designed the mechanical systems.

The ICS programs are written with the intention of controlling the machine's movement and behavior within the mechanical engineers design specification. After the program has been written, it is compiled and transferred, also known as “downloaded”, to the ICS Central Processing Unit (CPU). The ICS CPU(s) will execute the program and control the physical devices based on the program in order to control the process or the machinery. The ICS program running on these embedded devices will:
Read the inputs wired or networked into the ICS
Update the input data table or database based on the current value
Execute or run the program and mathematical algorithms based on the input data table or input database
Update the program variables and device output data table or database based on values after the program execution is complete.
Electrically update the physical output electrical signals to match the ICS's output data table or database.

As mentioned earlier, the machine's mechanical systems are designed by mechanical and process engineers while the electrical engineering and programming of the ICS's are designed by electrical engineers, automation engineers and even technicians. The mechanical systems and processes are carefully engineered with an intended function that is defined and designed by the mechanical and/or the process engineers. Because the mechanical engineer(s) are typically not the same person that will program the PLC, PAC, DCS or SCADA, a challenge exists to convey the proper and accurate sequencing of the physical devices to whomever will program the PLC or control system. Also, and equally as important, a mechanical engineer would be more likely to define improper sequencing that could lead to machine damage or even situations that could lead to the loss of life of operators, plant personnel or under more catastrophic situations, loss of life at a wider scale.

The ICS programmer must understand the proper physical device sequencing before programming the ICS system, therefore the automation engineer must seek out the mechanical or process engineer and ask the appropriate questions about each physical device in order to achieve a properly functioning machine. While it is possible the ICS programmer can gain experience with the sequencing of physical devices, the mechanical engineer should participate in the sequencing and misuse use cases to validate the machine program is sequencing the machine's physical devices as the mechanical engineer has intended.

### FIGURES

FIG. 1—this figure presents the Sequence Design tool-Sequence of Operations (SoO) Chart representation consistent with elements of the disclosure FIG. 2—this figure presents granular views of the elemental operations performed by an operating sequence consistent with embodiments of the invention.

FIG. 3—this figure presents a Sequence of Operations (SoO) chart presenting native and non-native PLC/PAC objects consistent with several embodiments of the invention.

FIG. 4—this figure presents a view of the event tag and object editor for a sequence design tool consistent with several embodiments of the invention.

FIG. 5—this figure presents a view of the Sequence Design Tool (SDT) sequence of events editor for a sequence design tool consistent with several embodiments of the invention.

FIG. 6—this figure presents a view of the Sequence Discovery and Display Tool (SDDT) process operation consistent with several embodiments of the invention.

FIG. 7—this figure presents a view of the creation of tag and data export files and ladder logic export files from the ladder logic processing in the SDT consistent with several embodiments of the invention.

FIG. 8—this figure presents a view of the ladder logic native and non-native elements consistent with several embodiments of the invention.

FIG. 9—this figure presents a graphical view of the data and entity relationships of a particular element consistent with several embodiments of the invention.

FIG. 10—this figure presents a graphical view of the data and entity relationships of multiple elements consistent with several embodiments of the invention.

FIG. 11—this figure presents a communication interface diagram that illustrates intended external communications consistent with several embodiments of the invention.

FIG. 12—this figure presents a non-limiting example of an MSoO chart consistent with several embodiments of the invention.

### DETAILED DESCRIPTION

A software tool that allows a mechanical or process engineer to accurately document the SoO, the MSoO and boundary conditions of the electrical and physical devices is required to validate the automation program(s) have been written to achieve the SoO and also protect against the MSoO and enforce the documented boundary conditions. The software tool will allow mechanical system drawings or mechanical system devices to be represented in the software tool to convey the proper SoO and MSoO as well as creating an SoO and MSoO chart and textual description to enable code completeness and correctness.

Machines used in industrial applications are designed by mechanical engineers. Mechanical engineers utilize physical devices, both input sensors and output devices, and physical structures to control the machine's movement and behavior. Proper sequencing and interpretation of the physical input devices is required for the machine to work as designed. The mechanical system(s) designers are in most cases not the person or persons that will program the ICS that is responsible for controlling the mechanical devices and structures.

The challenge for an ICS programmer to know what to program to control the machine properly is:
Typically, they have not designed the mechanical systems therefore they don't inherently know the proper SoO of the mechanical or process systems
They don't have a mechanical system background so therefore they can't derive the proper SoO for the devices
If the mechanical designer has given the ICS programmer a SoO, it will typically be drawn using a bar chart format or a spreadsheet program. This format will not allow for enough detailed information to describe alarm conditions, operational boundaries or what should happen if an unusual state transition has occurred.
If the mechanical system designer has given the ICS programmer a SoO, it will typically not contain the sequences of devices that should be avoided either for safety reasons or situations that could cause mechanical failure or even loss of human life is the wrong sequence is programmed or if a mechanical system isn't contained within the designed limits.

A Sequence of Operation tool allows all interested and knowledgeable contributors, especially the mechanical engineer(s) or machine designer(s), to document in an easily understandable method how the physical devices should be controlled by the ICS.

The Sequence of Operation (SoO) Design tool consists of four major components:
a) Sequence Design Tool used to design an accurate SoO and Misuse Sequence of Operation (MSoO) with Event definitions, fault and alarm conditions. The SoO tool also considers the definition of safeties for machine and human safeguarding and their functions related to machine operation.
b) Sequence Discovery and Display Tool (SDDT) that allow a program of a previously programmed system(s) to be imported to create an automatically generated SoO.
c) Data and External Interlock Interface definition tools in order to define the communications between an ICS and external systems.
d) Library functionality to store and version components which can include mechanical device descriptions, electrical device descriptions and automation code. The library tool allows the designer to define physical devices and their attributes so they can be utilized within the SoO and MSoO designs.

Sequence Discovery and Display tools are intended to ingest an existing Programmable Logic Controller (PLC), Process Automation Controller (PAC), Human Machine Interface (HMI), or Supervisory Control and Data Acquisition (SCADA) program that has been exported from an ICS vendor's proprietary format to the vendor's supported open format to generate an SoO. The existing open format programs may be converted to a Neutral Programming Language (NPL) which may then allow the creation of programming code and SoO visualization through the Sequence Design Tool (SDT).

Tags and Objects may be edited by a user through access to a tag and object editor screen. A Tag is a common industry term that is defined as a declaration of a variable within an automation program. Tags are basic data declarations with a defined data type. Objects are a more complex representation of an encapsulation of data and attributes of the object.

An Object is a common programming term that refers to an entity that encapsulates data, such as tags and possibly programming methods associated with the object. In an embodiment, a Tag and Object editor allows a SoO or MSoO designer to define Tags and Objects associated with the program to be created and operated. A tag, or data declaration, must have a unique name within the expressly designated namespace. The tag may point to a simple single datatype or may point to a more complex data structure or object type. An object type may be defined as a simple or complex data or object.

In an embodiment, object relationships are the key to SoO and MSoO verification. Every object within the PLC will have relationships to other objects in the PLC. Analyzing the object relationships is the heart of determining if the operation of the object performs as designed. An object can be a controllable element in which the value can be changed during code execution or a non-controllable element that is an object having a value that cannot be changed during code execution. In a non-limiting example, a PLC input may be a non-controllable element because the value of the PLC input is not meant to be changed by execution of a code segment. When an operational sequence is described by a Mechanical Engineer, the event is described as one or more values of the declared inputs or variables that must exist in order for the output, a controllable element, to change state, such as the state change from an on state to an off state. Through an understanding of how events are constructed, the design software tool may deconstruct the logic to know if the sequencing present in the code meets the requirements set by the Mechanical Engineer.

To describe machine events, a software tool provides a sequence of events editor. A designer may utilize the sequence of events editor to define events as a change in the status of a variable or variables that may cause a change to a single or multiple other variables. Events may utilize Programmable Logic Controller (PLC) internal or programmer created tags to construct the event(s), however an event is not a native construct of the PLC.

In an embodiment, the sequence design software tool may take vendor specific open format representation and append non-native constructs, where non-native constructs may consist of objects that are imported from external sources, to create a SoO. This step is referenced as an upload and append process. Typical objects that are non-native constructs to a PLC/PAC/DCS or SCADA programming environment may include, but are not limited to, states or machine states, phases or machine phases, events or complex events, event links such as finish-to-start, start-to-start, linked, finish-to-finish, and/or start-to-finish. These constructs may be appended to automation code through simple dialog boxes for an operation designer to fill out or by assigning states or phases that are automatically generated by the sequence design software tool.

The sequence design software tool is capable of removing the non-native automation vendor constructs in order to convert the Neutral Automation Language (NAL) created through the operation of the sequence design software tool back to vendor specific open format representations.

ICS systems when in online mode communicate via one or more industrial protocols. These protocols are described in detail in protocol documents developed by the protocol working group or an individual ICS vendor. Detailed protocol documentation is often available for purchase and some protocol vendors may even sell and support a Software Development Kit (SDK) to aid in the adoption of a specific protocol. This adoption of a specific protocol permits interested hardware and software adopters to communicate with devices that support that specific industrial protocol. In an embodiment, the sequence design software tool may incorporate any number of different ICS protocols into the sequence design software tool to communicate with ICS devices for the purpose of importing the program and/or monitoring current values of objects This communication may occur between the ICS device(s) and the sequence design software tool in order to retrieve real-time operational data.

In an embodiment, automation engineers visualize object relationships when thinking about creating code to control outputs or change the value of memory variables. These object relationships are considered in terms of how to initially energize a controllable element, how to maintain the state of the controllable element, and how to drop or de-energize the controllable element. The SDDT formalizes the three states of object relationships using programming techniques that list the initial energize logic, the maintain logic and the de-energize logic. The SDDT may present a visual representation of the relationship of objects related to a particular element.

The SDT may also have a library function that provides storage for verified and validated code snippets. These verified and validated code snippets may be created through the SDT or may be created by machine and equipment vendors and transmitted to the SDT library function to be stored for later use.

In an embodiment, no two programmers will program the same machine in the exact same manner to produce the desired output, and yet it is possible for the machine sequencing to be identical. A SoO contains controllable elements and event definitions in order to determine the required operational design. Although a machine control program may be created and coded in different ways and utilizing different coding languages, the functional equivalency may be checked or verified by evaluating the events required to complete the machine sequencing, and specifically the values of the variables that constitute the event, to cause a transition to another state, phase or alarm condition, as well as the corresponding controllable element values found in the code.

In a non-limiting example, a SoO requires that controllable element output A is TRUE when event 1 is true. The system may evaluate event 1 to determine if the sequence of operations is accurate. If the coded sequence requires that input 1 must be true and input 2 must be false, the system may check the code to determine that controllable element output A is TRUE when input 1 is true and input 2 is false. This sequence of steps becomes the minimum functional equivalency and no matter the style of programming or language utilized, the system can check to determine that this minimum functional equivalency has been met.

The SDT may also provide a Machine Learning function that is trained on how to recognize and utilize validated and verified code snippets from the SDT library of stored code snippets in the creation of verified PLC code for particular machine sequencing. The Machine Learning function may be trained to predict and identify particular machine elements, such as, but not limited to, pressure and flow valves, drive code and valve positioning and other operational elements, and automatically retrieve the functional code snippets from the SDT library and place into the machine sequencing to achieve a desired goal, sequence, or output.

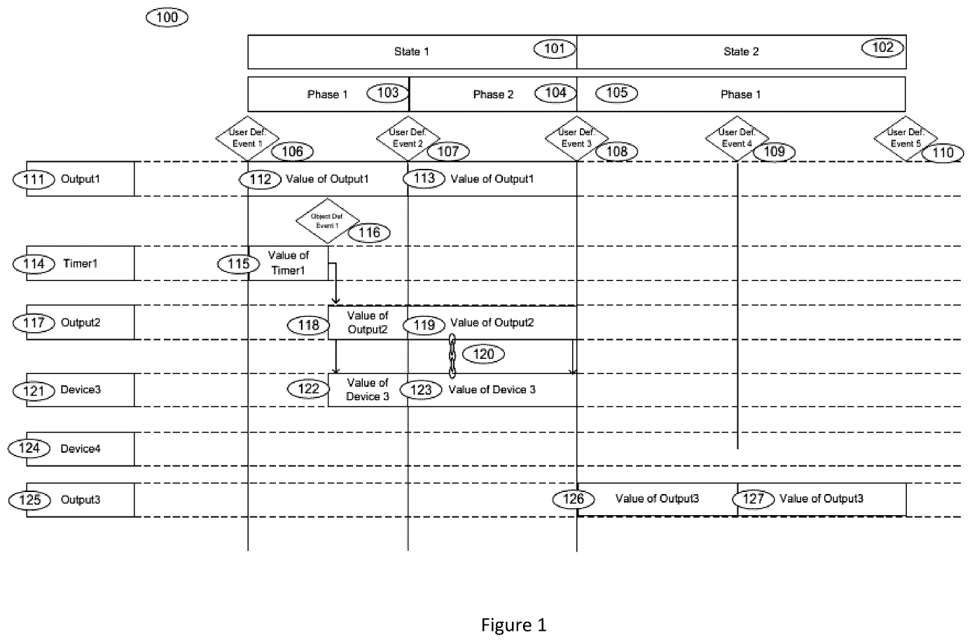

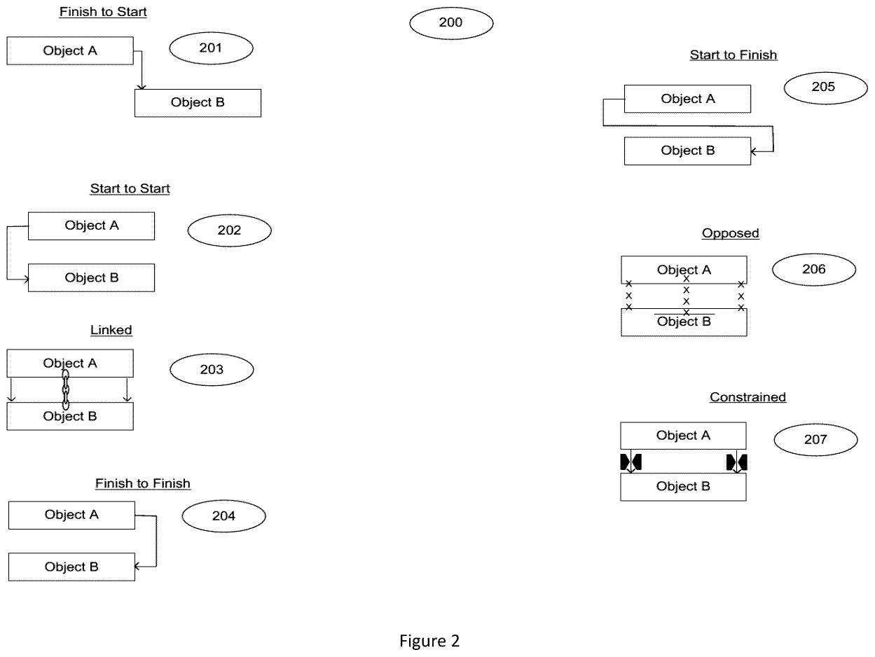

Turing now to FIG. 1, this figure presents the Sequence Design tool—Sequence of Operations (SoO) Chart representation 100 consistent with elements of the disclosure. It is common for processes being designed by a mechanical engineer or a process engineer to be described with reference to machine operations using the terms “states” (state 1 at 101, state 2 at 102), and “phases” (phase 1 of state 1 at 103, phase 2 of state 1 at 104, phase 1 of state 2 at 105). A machine state can be used to describe a higher-level process step whereas a machine phase is a sub-set of a machine state as represented in the figure. Machine states and phases are not a native construct of PLCS/PAC/DCS/SCADA, but rather help a mechanical engineer or process designer to articulate the functions of a machine. In an embodiment, a person trying to describe how a machine operates to use these terms while describing the SoO may strive for accuracy in presenting machine processes using these terms. During machine states and phases the designer may reference events, values of memory variables and/or inputs while describing how the specific output values are related to controllable elements.

The SoO, as presented in FIG. 1, may contain a visual representation of the Controllable elements, element values during a particular State or Phase, and the Event(s) that cause changes in the control values once the Event has occurred. When combined, these definable Controllable elements, States, Phases and Events present detailed documentation of the intended sequencing of the physical devices for the proper machine operation.

The intent of the SoO chart is to convey accurate and detailed information about the value or status of a controllable element to document specific steps in machine control or process. A machine state can be used to describe a higher-level process step or can be considered a container for a grouping of machine or process phases such as state1 101 and state2 102. A phase is a subset of a machine state that identifies specific conditions of controllable elements after an event has occurred (103, 104, 105).

User Defined Events: A Machine or Process Phase starts and ends based on user defined conditions or User Defined Events. User Defined Events are values of Controllable and Non-controllable objects that are used singularly or in combination to define a condition of values that must exist. The Controllable and Non-controllable values as used in the User Defined Events (106, 107, 108, 109, 110).

Item 111 Controllable Element, Output1: This item shows the SoO designer has defined a physical Output as a Controllable Element within the SoO chart. This element will have value changes during some of the States and Phases as defined by the designer of the chart.

Item 112 Controllable Element, Output1 Value During State 1, Phase 1: This item shows the value of Controllable Element, Output 1 during machine or process State 1, Phase 1.

Item 113 Controllable Element, Output1 Value During State 1, Phase 2: This item shows the value of Controllable Element, Output 1 during machine or process State 1, Phase 2

Item 114 Controllable Element, Timer1: This item shows a Controllable Element Timer is being defined and used within the SoO chart. In this non-limiting example, Timer1 starts at the beginning of Phase 1.

Item 115 Controllable Element, Timer1 Value: This item shows the value of Timer 1 during State 1, Phase 1.

Item 116 Controllable Element, Timer1 Object Defined Event: This item shows that Timer 1 has attributes associated with this Timer object. Non-limiting examples could include, Timer Timing attribute, Timer Done attribute, Timer Setpoint attribute, Timer Type such as “Timer Up Timer, Retentive Timer Type, Timer Off Timer, etc. A user can use an object's attributes to define an event.

Item 117 Controllable Element, Output2: This item shows the SoO designer has defined a physical Output as a Controllable Element within the SoO chart. This element will have value changes during some of the States and Phases as defined by the designer of the chart. In this particular non-limiting example, Output2 value changes after Timer1 is complete.

Item 118 Controllable Element, Output2 Value During State 1, Phase 1: This item shows the value of Controllable Element, Output 2 during State 1 Phase 1. It should be noted that the value change of Controllable Element Output2 does not change until Timer1 is complete.

Item 119 Controllable Element, Output2 Value During State 1, Phase 2: This item shows the value of Controllable Element, Output 2 during State 1 Phase 2.

Item 120 Controllable Element Linked: This item shows that Output 2 change is state is linked to Device 3. This means that when Output2 has a value change, Device 3 must follow with a state change.

Item 121 Controllable Element Device 3: This item shows the declaration of a device which can differ from just a simple output. A device is an encapsulation of associated attributes related to a device's description.

Item 122 Controllable Element Device3 Value During State 1, Phase 1: This item shows the value of Device 3 during State 1, Phase 1. Also note in this non-limiting example that the Value of Device3 is linked to Output 2, meaning that when Output2 changes value, Device3 must also change value.

Item 124 Controllable Element Device4: In this non-limiting example, Device4 is declared but not used in State 1, Phases 1 or 2 nor in State2, Phase 1.

Item 125 Controllable Element, Output3: This item shows the SoO designer has defined a physical Output as a Controllable Element within the SoO chart. This element will have value changes during some of the States and Phases as defined by the designer of the chart. In this particular non-limiting example, Output3 value in State2, Phase 1.

Item 126 Controllable Element, Output3 Value During State 1, Phase 2: This item shows the value of Controllable Element, Output 3 during State 2 Phase 1 while User Defined Event 3 is active but not while User Defined Event 4 is active.

Item 127 Controllable Element, Output3 Value During State 2, Phase 1: This item shows the value of Controllable Element, Output 3 during State 2 Phase 1 while User Defined Event 4 is active but not while User Defined Event 5 is active.

Turning now to FIG. 2, this figure presents granular views of the elemental operations performed by an operating sequence consistent with embodiments of the invention at 200. The finish to start operation is shown at 201. This operation shows a concise view of how object B's state changes after a change in state of object A. The start to start operation is represented at 202. In this operation, object B's state may change after the state of object A has changed. In a non-limiting example of this operation, if object A is a timer and object B is an output, when the object A timer starts, object B output changes state. The linked operation is represented at 203. In this operation the states of object A and object B are linked. Object A and object B values do not have to be the same, but when object A's state changes, object B's state may also change. The finish to finish operation is represented at 204. In this operation, when object A's states changes, object B's state changes. In a non-limiting example of this operation, if object A is a timer and object B is an output, when the time interval of object A is complete, object B output will change state. The start to finish operation is represented at 205. In this operation object B cannot complete or change states until object A begins or changes states. In a non-limiting example of this operation, if object A is an output and object B is a timer, the timer of object B cannot start until the object A output has changed state. The opposed operation is represented at 206. In this operation the state change of an object B is linked to the state change of an object A. In a non-limiting example of this operation, if the state of object A is a Boolean “true”, then the state of object B is a Boolean “false”. The constrained operation is represented at 207. In this operation object B's state change is linked to object A state change such that object A's value constrains or limits object B's value.

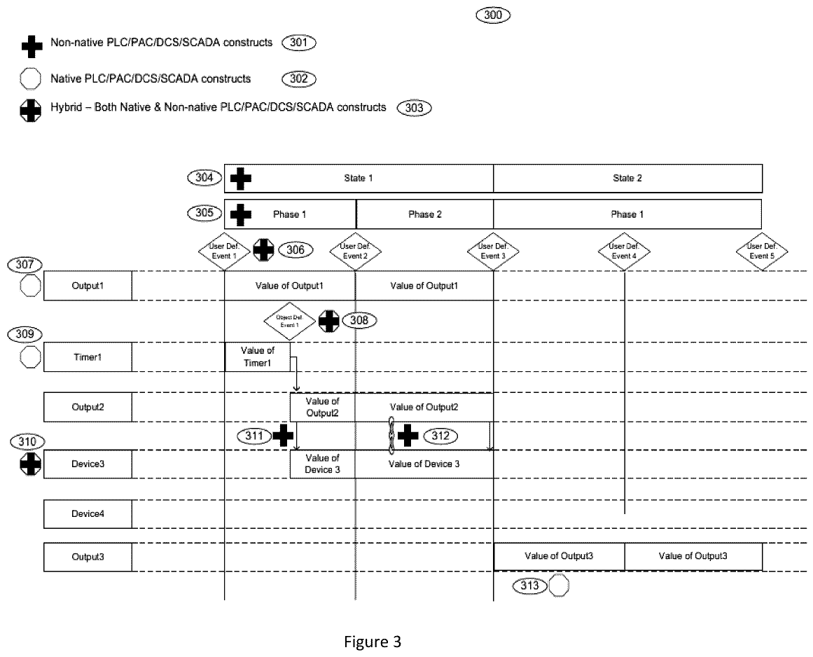

Turning now to FIG. 3, this figure presents a Sequence of Operations (SoO) chart presenting native and non-native PLC/PAC objects consistent with several embodiments of the invention at 300. The SoO chart contains elements including, but not limited to, states, phases, events, controllable elements, controllable element values, and operations such as finish-to-start, and linking elements. This figure illustrates that some elements on a Sequence of Operation chart are natively contained within an embedded system like a PLC, PAC, DCS or SCADA and some elements are not. To describe a machine or process more fully or more accurately, a designer wants to express with additional elements beyond those natively found within embedded system to better document how a machine or process was intended to be controlled. Understanding that native embedded system elements are too limiting to document the details of how the embedded program should be written is key. The SoO allows a designer to fully describe the details of each physical and virtual value during all the steps of machine or process control.

The legend element at 301 represents non-native PLC/PAC/DCS and/or SCADA objects or declarations found on the Sequence of Operation and Misuse Sequence of Operation charts that are not natively found within the design or runtime environment of a PLC/PAC/DCS/SCADA embedded platform. The legend element at 302 represents native PLC/PAC/DCS and/or SCADA objects or declarations found on the Sequence of Operation and Misuse Sequence of Operation charts that are natively found within the design or runtime environment of a PLC/PAC/DCS/SCADA embedded platform. The legend element at 303 represents a hybrid value of both native and non-native PLC/PAC/DCS and/or SCADA objects or declarations found on the Sequence of Operation and Misuse Sequence of Operation charts that are constructed of native objects found within the design or runtime environment of a PLC/PAC/DCS/SCADA embedded platform but these complex objects are not explicitly found within.

The concepts of States are not a native construct within an embedded device like the PLC, PAC, DCS or SCADA at 304. These constructs are used to describe a machine or process step in a more natural and more accurate way that is not contained within the embedded device.

The concepts of Phases are not a native construct within an embedded device like the PLC, PAC, DCS or SCADA at 305. These constructs are used to describe a machine or process step in a more natural and more accurate way that is not contained within the embedded device.

User Defined Events 306 are constructed from native tag values however the encapsulating method of defining tag values to define an event are a non-native concept.

A controllable element output 307 is a native construct that will be found in embedded devices such as PLC's, PAC's, DCS's and SCADA.

The concept of a native object defined event 308 such as a timer having attributes that are also found natively within the embedded device such as a PLC, PAC, DCS or SCADA is typical however having these attributes associated with an event is a non-native construct.

A Timer object is a common native controllable element construct 309 within an embedded device such as a PLC, PAC, DCS and SCADA.

A controllable element device 310 in a non-native construct as a device is a container for an object with one-to-many attributes. This varies from the concept of a simple tag or data structure insomuch as a Device can have controllable properties such as physical representation as well as virtual data structures. This concept is not a native construct of a PLC, PAC, DCS or SCADA.

In this non-limiting example when a change of the value of Output2 is linked to the value of Device3, meaning that when the value of Output2 occurs, the value of Device3 must also change (311, 312).

A controllable element output object value 313 is a common native construct within an embedded device such as a PLC, PAC, DCS and SCADA.

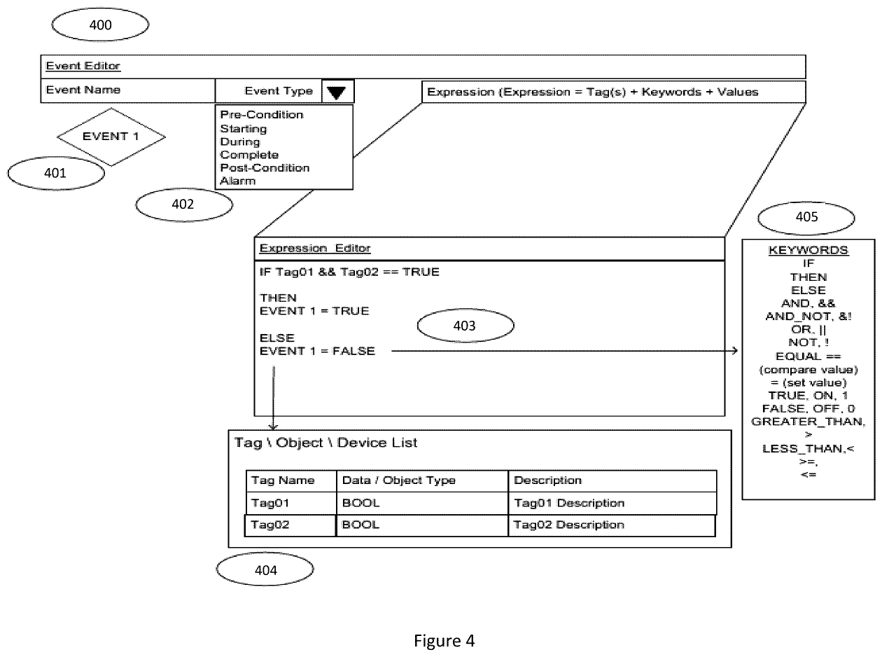

Turning now to FIG. 4, this figure presents a view of the event tag and object editor for a sequence design tool consistent with several embodiments of the invention. The event tag and object editor presents to a user an interface screen 400 into which a user may input and edit expression elements. The event editor 400 may represent an event utilizing an event name 401 and present a drop-down menu for event type 402. The event type 402 may be a pre-condition, starting, during, complete, post-condition, alarm or other event identified as available for inclusion by the SDT.

Event types are used to determine if the event should be categorized as a “Pre-condition” for another event to occur, a “Starting” condition for the event to start, a “During” condition where something must occur during the defined event, a “Complete” condition where the event signal the completion of an event, a “Post-Condition” declaration where the event is done but something needs to be done after the event or an “Alarm” event. These Event Types are considered meta data about the event and have relevance to the designer of the SoO chart so that this detail can be attached to an Event.

The expression editor 403 provides an ability for users to create an expression for later operation that includes tags, keywords and values for the expression of the logic to be followed. A tag will typically have a name field, a description field, and a data type field such as Boolean, Integer, String, or other type field descriptors. The expression editor uses tags and object attributes to construct an expression to define the event. The event editor uses keywords to create the expressions in order to determine if the event is true or false. The tags may be declared to reference a virtual memory location or tags may refer to real physical devices such as inputs and outputs. Tags are used in the automation program expression as variables. An object refers to an entity that encapsulates data, such as tags and possible programming methods associated with the object. In a non-limiting example, a valve object that logically represents a physical valve and the properties and attributes of the valve, may have data or tags related to the output voltage span and the number of pressure ports available for the valve. The valve object may have methods such as “open valve command”, “close valve command”, “bidirectional flow valve”, or “pressure valve” which may define the commands and the attributes that the valve object supports.

The event editor screen 400 provides a user access to a tag/object/device list for use in specifying tags 404 that are required for the expression of logic to be followed. Tags, Objects, Object Attributes, Devices and Device Attributes are created with the Tag and Object Editor but are used within the Event Expression Editor. The expression editor 403 also provides access to a plurality of keywords 405 that may define operations to be performed when the expression of logic is transmitted to the machine to achieve the results required by the logic expression. The tags and objects as presented in the event editor screen 400 provide the foundation for all logical comparisons, declared events, and SoO and MSoO entries. The tags and objects must be declared before use in any program, SoO, or MSoO.

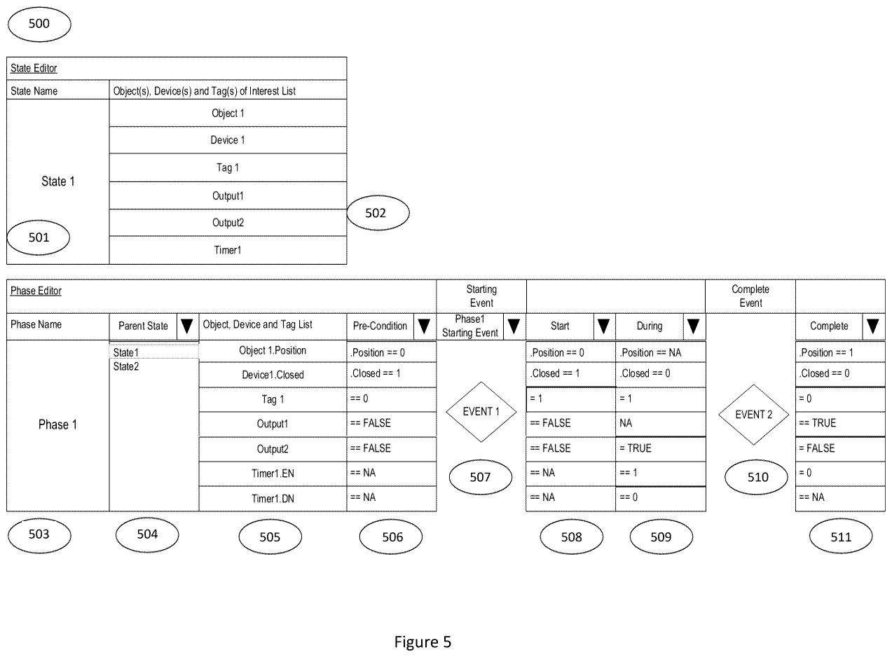

Turning now to FIG. 5, this figure presents a view of the SDT sequence of events editor for a sequence design tool consistent with several embodiments of the invention. When programming a machine to perform a particular sequence of operations or specifically provide a sequence for a particular output, an automation programmer may monitor inputs for changes in state to provide for changes in the state of memory and physical outputs. This editor permits any contributing designer to encapsulate and document different major process step or machine sequence. The intent of formally documenting machine states and phases is to help the designer encapsulate the physical devices and variables that are of interest during identified process steps. In a non-limiting example, the motor of a particular machine may not start until an operator either pushes a physical motor start pushbutton, or perhaps a virtual motor start pushbutton on a Human Machine Interface (HMI) operator screen. The motor may be activated through the user selection of the virtual motor start pushbutton event, which then energizes the motor starter(s).

To provide a user with the ability to manage machine states, the SDT provides the user with a Sequence of Events (SoE) editor screen 500. Events can be defined as a change in the status of a variable or variables that may cause a change to a single or multiple other variables.

State Editor 501: This item allows a designer to formally document a machine or process State. A State is used to identify an important step or steps in the process and correlate the pertinent physical devices associated to achieve or control the process during that named State. A State also identifies the tags and values that are associated with the State as well.

Object(s), Device(s) and Tags of Interest List 502: This item allows the designer to create a list of objects, devices and tags that are involved in the named State. The designer can pull names from the entire list of objects, devices and tags to create a focused list of relevant entities that are involved with this portion of the process or machine steps. While this seems obvious, it is very difficult when dealing with a PLC, PAC, DCS or SCADA system to narrow down the relevant entities during a particular machine State or Phase. This editor allows the designer to pick out the related entities for each State or Phase Phase Name 503: This part of the Phase Editor allows a designer to name the Phase. A Phase is a child of a defined State and can be considered as a particular step in the process or machine control process during the defined State.

Parent State 504: This item allows a named Phase to formally identify which parent State it is a child of. This becomes relevant when deriving the Sequence of Operation chart from this data.

Object, Device and Tag List 505: This list contains the physical and virtual tags that are involved in the named State and Phase. This list can be derived from the early State Editor or the designer can browse throughout the entire project object, device or tag list to identify which entities are involved with the named Phase.

Pre-Condition 506: This list identifies the variable value that must exist in order for the named Phase to begin. Some of the physical or virtual values will not be applicable while others are important for the phase to begin.

Starting Event 507: This item identifies the Event that occurs in order for the phase to begin.

Noting that some of the Pre-Conditions must be met in addition to the Starting Event. A non-limiting example of a Pre-condition requirement to be met could be a certain safety gate being cycled to prove that the safe position limit switch is not stuck that is represented by a variable as well as the gate physical monitoring switch indicating that the gate is electronically closed. A Starting Event could be an external robot signaling that the robot arm is retracted while the clamp is showing as retracted and the pressure is below a defined minimum value. Pre-Conditions and Starting Events work in conjunction to identify Phase Starting conditions.

Start 508: This column represents the variable values that occur when the named phase starts.

Once a phase has started, certain variables and physical device values will change once the phase has started. Identifying the values that change once the phase has started is critical to understanding the normal sequencing of these values during the phase.

During 509: This column represents the variable values that occur when the named phase is running or active. Once a phase is active, certain variables and physical device values will change once the phase has started. Identifying the values that change once the phase is active is critical to understanding the normal sequencing of these values during the phase.

Complete Event 510: This item identifies the Event that occurs in order for the phase to end or to be considered complete. Events are designed with the Event Editor and a Phase Complete Event is simply picked from the list of Events created by the Event Editor.

Complete 511: This non-limiting event represents the pertinent variable values once the named phase is complete. Some values are important to document once the Phase is complete while other variables that were pertinent during the phase are not important once the phase has completed.

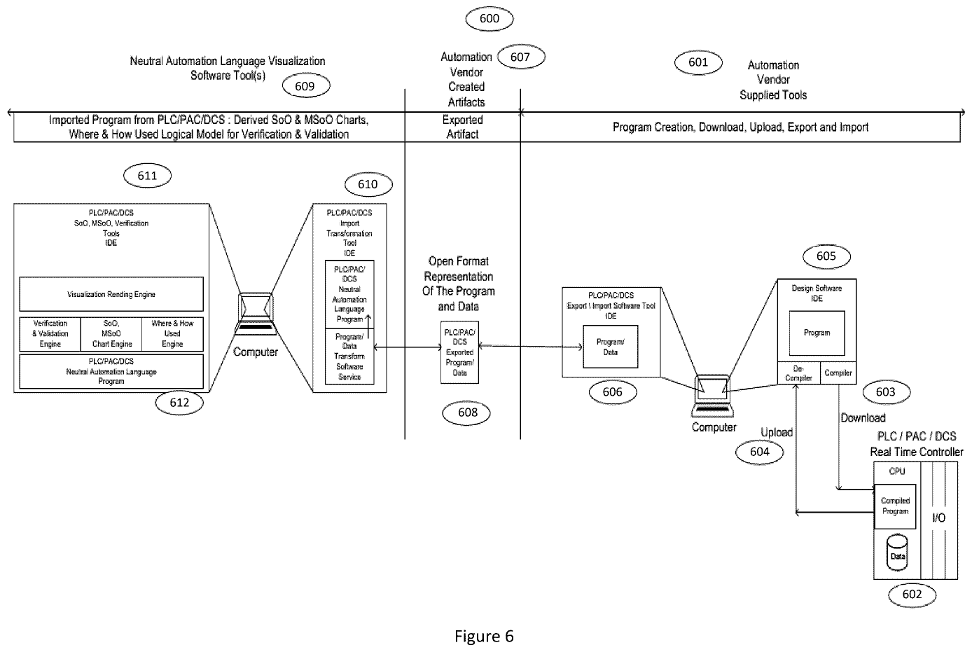

Turning now to FIG. 6, this figure presents a view of the workflow process by which an embedded program is imported and exported into the Sequence Discovery and Display Tool (SDDT) consistent with several embodiments of the invention. The SDDT process FIG. 600 is provided to highlight the key components of the SDT as well as the workflow to move programs into and out of the SDT and an automation vendor's software tools. At 601 automation vendor supplied tools permit process sequence program creation, download, upload, import and export of program(s) and data. Vendor supplied software tools are used to interact with their own brand and models of automation devices. A PLC/PAC/DCS real time controller device 602 takes downloads 603 and provides uploads 604 of program operation information to and from the design software IDE at 605. At 606 the PLC/PAC/DCS import/export software tool Integrated Design Environment (IDE) is used to create an open format representation. This import/export tool is also capable of ingesting or also known as “importing” artifacts presented in the open format representation and converted to vendor's proprietary format which will be used in the automation vendor's Design Software IDE. At 607 this represents the capability of an automation vendor to support an open format representation of their data and programs created with their own IDE. At 608 the open formation representation of the program is presented and data that can be utilized by third party software tools in order to examine and manipulate the original program and data representation. At 605, the automation vendor IDE is used to create, modify, and monitor the ICS programs that are used to control mechanical systems. The IDE may also have functions that allow an automation program to be compiled and transferred from the computer to the PLC CPU and memory. The act of transferring a program from the computer to the PLC is commonly called “downloading” while transferring the program from the automation device to the computer is called “uploading”. The upload functionality is commonly used to pull the program from the PLC CPU to permit the program that is in operation to be analyzed without possessing the original program. Uploading the running program allows for program and data inspection, as well as conducting a comparison of the operating program to an offline or archived program file.

The automation vendor proprietary program and data can be transformed by the PLC/PAC/DCS import/export software tool IDE 606 to convert a proprietary format to an open format that can be used by the PLC/PAC/DCS import transformation tool IDE 610. The open format representation of the ICS program and data can now be used by the PLC/PAC/DCS/SoO/MSoO tool found in 611.

The data imported to the PLC/PAC/DCS import transformation tool IDE 610 is translated into formats for use in verification and validation of derived SoO and MSoO logical models. A set of Neutral Automation Language Visualization tools 609 may use a plurality of PLC/PAC/DCS verification tools including a visualization rending engine, a verification and validation engine, an SoO and MSoO chart engine, and a where and how used engine 611 to perform verification and validation of the process steps for a particular operation on the machine or device. The exported ICS program and data may be transformed with a program transform software service software parser to create a neutral automation language program. A PLC/PAC/DCS neutral automation language program may provide evaluation and transformation services to place the imported data into a neutral, usable format. With the original program converted to neutral automation language program, the SDT and SDDT may visualize the program as an SoO and also generate visual representations of “where and how used” interactive graphical reports.

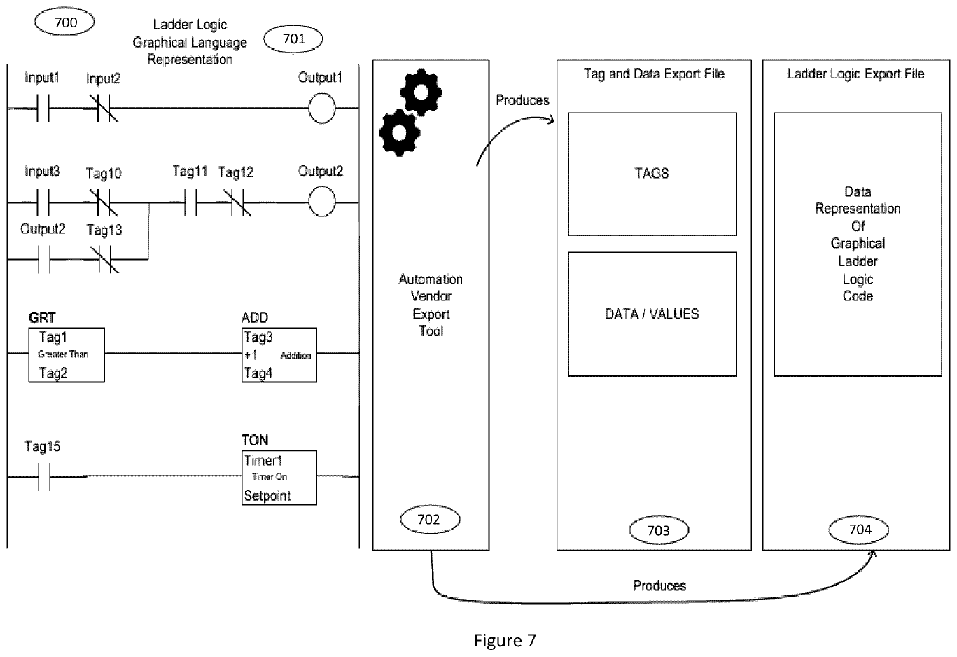

Turning now to FIG. 7, this figure presents a view of an automation vendor typical ladder logic export consistent with several embodiments of the invention. At 700, in a non-limiting example, the ladder logic graphical language screen presents a view of the ladder logic graphical language representation showing that a graphical language like ladder logic may be converted into two separate artifacts. One artifact represents the tag and data information while the second artifact represents the actual code.

In a non-limiting implementation, Ladder Logic Graphical Language Representation is shown at 701. Ladder Logic is a graphical language supported by most automation vendors. Additional ICS languages may be used to implement the graphical language representations such as, in non-limiting examples, function block, structured text, and sequential function charts. An automation vendor's IDE allows a designer to create data and program code. An export tool must export both data and program information and provide an explanation of the export format. This is commonly supported by most automation vendors.

The Automation Vendor Export Tool is shown at 702. This item represents an automation vendor's export tool. The export tool is typically responsible to export both data and program code as the program code contains data, and they are typically not separable. The Tag and Data Export file is presented at 703. This item represents a tag and data values database.

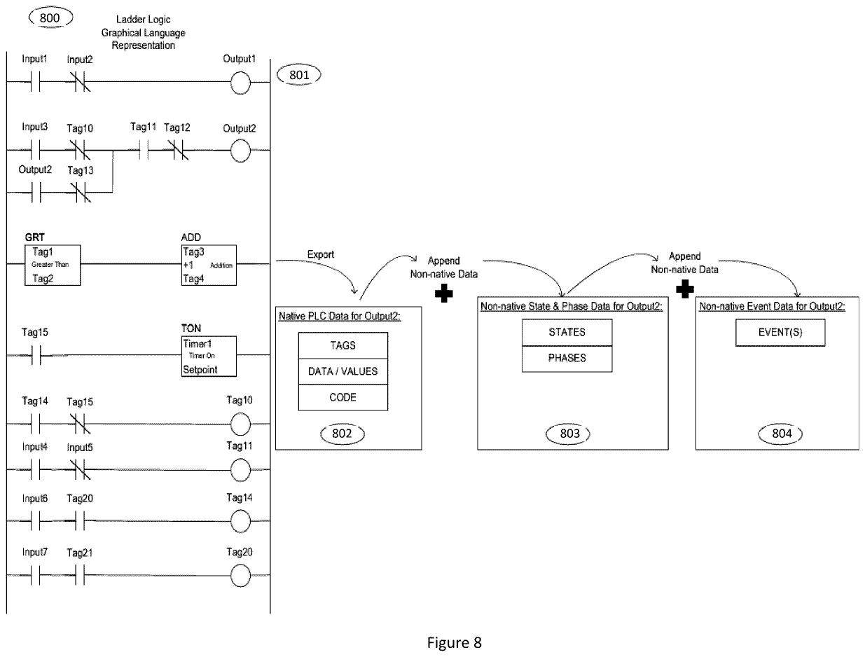

The Ladder Logic Export File is shown at 704. This item represents the data representation of the graphical language of Ladder Logic. Most ladder logic exports are represented with a textual representation of the graphical language. a view of the ladder logic native and non-native elements consistent with several embodiments of the invention Turning now to FIG. 8, this figure presents. Not all objects that are used to create a SoO chart 800 are natively found within an embedded system like a PLC, PAC, DCS, or SCADA system. In order to more accurately describe the proper sequencing of physical devices found on a machine or in a process, one must add non-native objects to native objects to get a detailed and documented sequencing.

A graphical representation of Ladder Logic Graphical native object found within the embedded system of a PLC is shown at 801. Other graphical and non-graphical ICS languages such as, but not limited to, Function Block, Structured Text, and Sequential Function Chart could also be represented in this example.

A Native PLC file for Output 2 is shown at 802 and specifically as it relates to the non-limiting example of a physical device named Output2. The exported file contains tags, data/values and the code.

A Non-native State and Phase Data for Output2 is shown at 803. This non-limiting example illustrates that non-native data such as States and Phases need to be appended to the native data in order to get a full representation of information that relates to objects found inside the embedded controller.

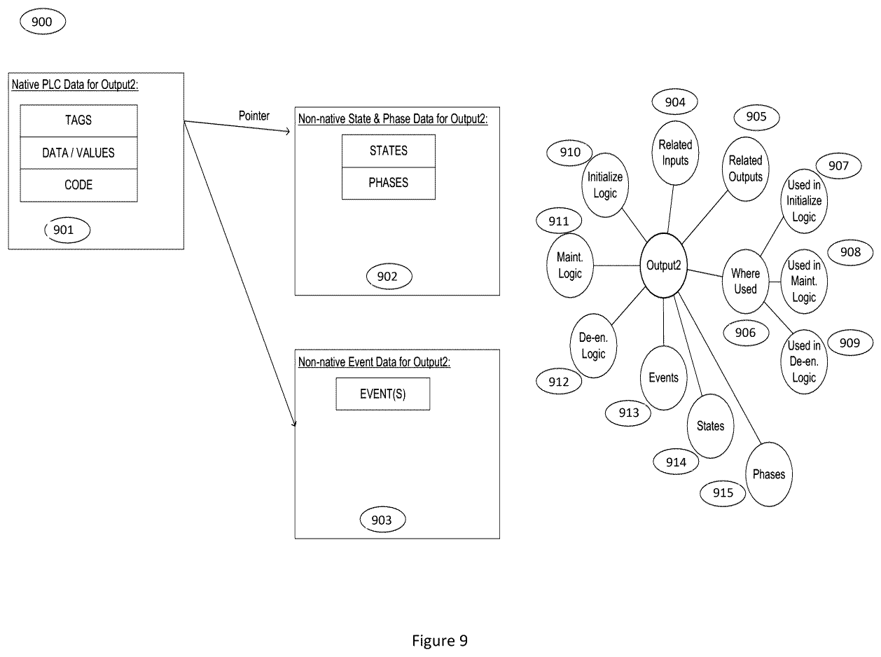

Turning now to FIG. 9, this figure presents a view of the ladder logic native and non-native element relationships consistent with several embodiments of the invention. In a non-limiting example, this figure illustrates that native elements within an embedded system such as a PLC, PAC, DCS or SCADA have relationships between other native objects and these can be visualized in order to gain an understanding of how the code is constructed 900. The figure also illustrates that non-native objects created within the SoO, MSoO and other tools will also have relationships to native and non-native objects. Relationships may be added to the visualization engine in order to show in a graphical format the relationships of code elements during specific portions of the program scan.

This item represents a non-limiting example of the Native PLC Data tags, data/values and code for a physical output named Output2 at 901.

This item represents appended non-native State and Phase data as it relates to a non-limiting example for Output2 902.

This item represents appended non-native Event data as it relates to a non-limiting example for Output2 903.

This item represents any related physical inputs to the non-limiting example of Output2 904.

This item represents any related physical outputs to the non-limiting example of Output2 905.

This item represents where the non-limiting example Output2 is used in the automation code 906.

This item represents where the non-limiting example Output2 is used in other objects initialization code. Automation code designers may use this output in order to initialize another portion of logic 907.

This item represents where the non-limiting example Output2 is used in other objects maintain code. Automation code designers may use this output in order to maintain an energized state of another portion of logic 908.

This item represents where the non-limiting example Output2 is used in other objects de-energized code 909. Automation code designers may use this output in order to de-energize another portion of logic.

This item represents the non-limiting example of Output2 Initialize logic. Initialize logic is referred to as the logic or code that has been written in order to energize Output2 910. It can be thought of as the initial conditions that must exist in order for Output2 to be energized.

This item represents the non-limiting example of Output2 Maintain logic 911. Maintain logic is referred to as the logic or code that has been written in order to keep Output2 energized. It can be thought of as the conditions that must exist in order for Output2 to remain energized.

This item represents the non-limiting example of Output2 De-energize logic 912. De-energize logic is referred to as the logic or code that has been written in order to de-energize Output2. It can be thought of as the conditions that must exist in order for Output2 to be de-energized.

This item represents the non-limiting example of Output2 and the Events related to this output 913.

This item represents the non-limiting example of Output2 and the States related to this output 914.

This item represents the non-limiting example of Output2 and the Phases related to this output 915.

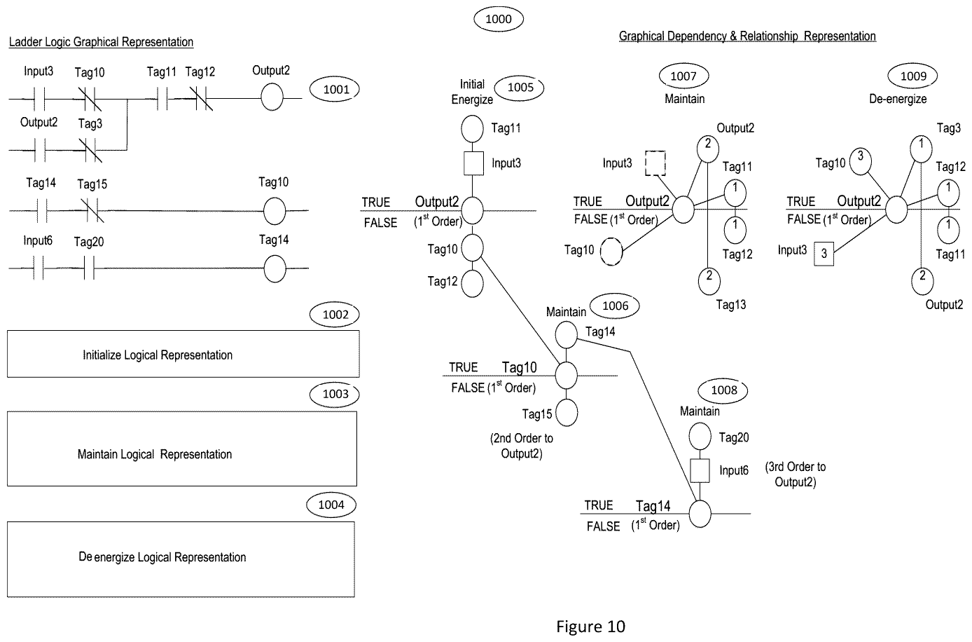

Turning now to FIG. 10, this figure presents a view of the ladder logic database and ordered initialize, maintain, and de-energize process steps consistent with several embodiments of the invention. In a non-limiting example, the concepts of initialization, maintain, and de-energization code are presented 1000. While nothing formal exists in traditional programming to recognize these three distinct states, this tool makes the code designer aware of these distinctions. By separately visualizing these three states, it emphasizes these states exist and makes the designer aware of how the code has been constructed. The three states also enable the designer to validate if the code meets the requirements driven out from the SoO and MSoO. This visualization also shows the relationship between code elements to not only insure the SoO and MSoO has been met but also is useful for online troubleshooting.

This non-limiting example of a ladder logic graphical presentation represents the code that initializes, maintains and de-energizes Output2 1001. The code represented here serves as the basis for the rest of the figure.

This non-limiting example represents the initial energize logical representation of a Boolean expression for the logic that will energize the coil Output2 1002.

This non-limiting example represents the maintain logical representation of a Boolean expression for the logic that will keep the coil Output2 energized 1003.

This non-limiting example represents the de-energize logical representation of a Boolean expression for the logic that will keep de-energize the coil Output2 1004.

Item 1105 Graphical Dependency & Relationship Representation, Initial Energize: his non-limiting example shows the graphical dependency and relationship representation of the intended logical path that the logic designer intended for Output2 to be initially energized 1005. With this type of visualization format, any item above the TRUE/FALSE line must evaluate “TRUE”. Any item below the TRUE/FALSE line must evaluate “FALSE”. In this non-limiting example, Tag11 and Input3 are above the TRUE/FALSE line so therefore must evaluate “TRUE”. Tag10 and Tag12 are below the TRUE/FALSE line and must evaluate “FALSE” in order for Output2 to energize.

This non-limiting example shows the graphical dependency and relationship representation for the intended logical path that the logic designer intended for Tag10 to maintain its energized state 1006. With this type of visualization format, any item above the TRUE/FALSE line must evaluate “TRUE”. Any item below the TRUE/FALSE line must evaluate “FALSE”. In this figure Tag10 has a relationship with Output2's Initial Energize condition. Tag10 must evaluate as “FALSE” in order for Output2 to energize. Tag10's logic is referred to as “Second Order Logic” affecting Output2.This means that the ladder logic or code directly in Output2's ladder code is referred to First Order code. The ladder logic or code that is referenced in the First Order code and can affect it indirectly is called Second Order code. In this non-limiting example, the ladder code that is directly in Tag10's rungs are considered First Order for Tag10 but Second Order for Output2

This non-limiting example shows the graphical dependency and relationship representation of the intended logical path that the logic designer intended for Output2 to maintain its energized state 1007. With this type of visualization format, any item above the TRUE/FALSE line must evaluate “TRUE”. Any item below the TRUE/FALSE line must evaluate “FALSE”. In this view, one variable, Tag10, and physical Input3 have no bearing on maintaining the energized state of Output2. The designation of a “2” is placed inside the Output2 circle above the TRUE/FALSE line. This value indicates that a second, and perhaps an unintended path exists that could keep Output2 energized.

These indicators help the designer realize if there are unintended logical paths that could maintain the state of an output or a memory variable. Additionally, Tag11 and Tag12 have a “1” inside their respective circles. These values indicate this is the intended path in which the designer expects the logic to solve in order to keep Output2 energized.

This non-limiting example shows the graphical dependency and relationship representation of the intended logical path that the logic designer intended for Tag14 to maintain its energized state 1008. With this type of visualization format, any item above the TRUE/FALSE line must evaluate “TRUE”. Any item below the TRUE/FALSE line must evaluate “FALSE”. In this view Tag14 has a relationship with Tag10 which affects Output2's Initial Energize condition. Tag10 must evaluate as “FALSE” in order for Output2 to energize. Tag14 has a relationship with Tag10, which affects Output2. When Tag14 has a value of “TRUE” then it could affect Tag10 which affects Output2.

This non-limiting example shows the graphical dependency and relationship representation of the intended logical path that the logic designer intended for Output2 to be de-energized 1009. With this type of visualization format, any item above the TRUE/FALSE line must evaluate “TRUE”. Any item below the TRUE/FALSE line must evaluate “FALSE”. In this view Tag3 and Tag12 solving as “TRUE” is the intended path to de-energize Output2. Additionally, Tag10 must also solve “TRUE” and is labeled as a “3”. In this view Input3 is below the TRUE/FALSE line and must be “FALSE” in order for Output2 to de-energize. The labeling of “3” on both of these variables indicate that if both these variables are not in the intended “TRUE” and FALSE” states, then Output2 will not de-energize.

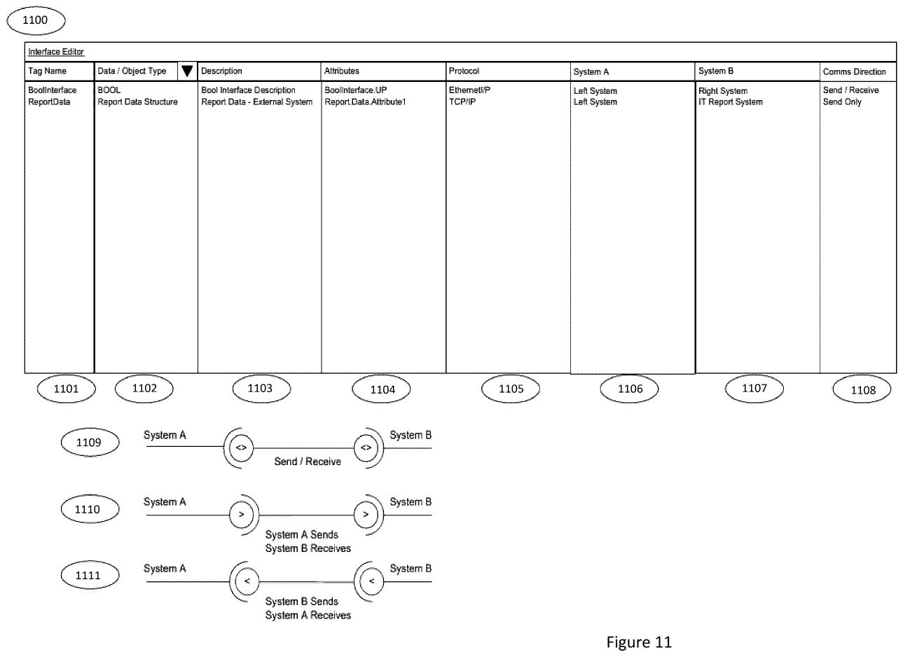

Turning now to FIG. 11, this figure presents a view of the system and external interface editor screen consistent with several embodiments of the invention. This figure illustrates how system and external interfaces are formally described and documented 1100. It is often overlooked with what systems embedded devices such as PLC's, PAC's, DCS's and SCADA system are supposed to communicate. This figure presents a view for the formalization of the communication and data structures with which these systems are supposed to be communicating. Especially looking at these systems through the lens of security, it can be established what systems, and more specifically what data, should be sent and received from each system.

At 1101, this item defines the variable or tag name associated with the communication interface.

At 1102, this item defines the data type or data structure that is associated with the communication interface.

At 1103, this field allows the designer to textually describe the data or data structure.

At 1104, this field allows the designer to assign any attributes of the object or data structure as defined by the data or object type. A non-limiting example could be a timer that has a attribute of “Timer Done” which can be used in this context.

At 1105, this field allows the designer to designate a protocol so the designated interface can parse through the protocol to inspect or enforce the protocol boundaries.

At 1106, this refers to one of the systems that will participate in the identified communications.

At 1107, this refers to one of the systems that will participate in the identified communications.

At 1108, this field indicates if the interface is a Send Only, Receive Only or a Send and Receive Interface.

At 1109, this non-limiting example shows that an interface designated as a Send and Receive Interface can both send and receive communications.

At 1110, this non-limiting example shows that an interface designated as a Send Only Interface can only send but not receive communications.

At 1111, this non-limiting example shows that an interface designated as a Receive Only Interface can only receive but not send communications.

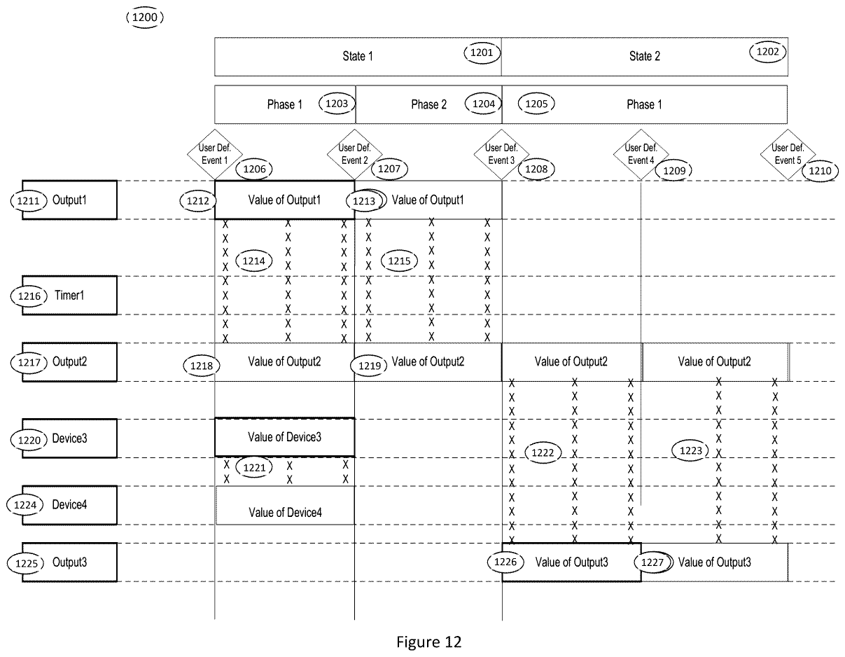

Turning now to FIG. 12, this figure presents a view of a Misuse Sequence of Operations (MSoO) chart consistent with several embodiments of the invention. The MSoO chart is used by the designer to document specific steps in machine control or process which should never exist 1200. It should also be noted that if this condition does exist, the designer can designate what actions are appropriate to minimize or eliminate machine or device, process or bodily harm.

Items 1201 and 1202; Machine or Process State: A machine, device, or process state can be used to describe a higher-level process step or can be considered a container for a grouping of machine or process phases such as those represented at 1203, 1204, and 1205.

A phase is a subset of a machine or device state that identifies specific conditions of controllable elements after an event has occurred (1203, 1204, 1205). A phase has a beginning and an end as defined by events. Events can include alarm conditions, Misuse conditions and normal conditions.

A machine, device, or process phase starts and ends based on user defined conditions or User Defined Events (1206, 1207, 1208, 1209, 1210). User Defined Events are values of Controllable and Non-controllable objects that are used singularly or in combination to define a condition of values that must exist. The controllable and non-controllable values as used in the User Defined Event.

The MSoO designer has defined a physical Output as a Controllable Element within the MSoO chart at 1211. This element will have value changes during some of the States and Phases as defined by the designer of the chart.

This item shows the value of Controllable Element, Output 1 during machine, device, or process State 1, Phase 1 at 1212. The MSoO chart also shows that Output1 and Output2 should not be on at the same time.

This item shows the value of Controllable Element, Output 1 during machine, device, or process State 1, Phase 2 at 1213. The MSoO chart also shows that Output1 and Output2 should not be on at the same time.

This non-limiting example of “Opposed Link” indicators show that Output1 and Output2 should never be on at the same time at items 1214 and 1215.

This item shows a controllable element timer defined event which has no misuse case at 1216.

The Controllable Element, Output2 shows the MSoO designer has defined a physical Output as a Controllable Element within the MSoO chart 1217.

This item shows the value of Controllable Element, Output 2 during machine, device, or process State 1, Phase 1 at 1218. The MSoO chart also shows that Output1 and Output2 should not be on at the same time.

This item shows the value of Controllable Element, Output 2 during machine or process State 1,Phase 2 at 1219. The MSoO chart also shows that Output1 and Output2 should not be on at the same time.

This item shows the declaration of a controllable element for a device which can differ from just a simple output at 1220. A device is an encapsulation of associated attributes related to a device's description.

This item shows the value of Device 3 during State 1, Phase 1 at 1221. The MSoO chart also shows that Device3 and Device4 should not be on at the same time.

This item shows the value of Output2 during State 1, Phase 1 at 1222 and 1223. The MSoO chart also shows that Output2 and Output3 should not be on at the same time.

This item shows the value of Device4 during State 1, Phase 1 at 1224. The MSoO chart also shows that Device3 and Device4 should not be on at the same time.

This item shows the MSO designer has defined a physical Output as a Controllable Element within the MSoO chart at 1225. This element will have value changes during some of the States and Phases as defined by the designer of the chart.

This item shows the value of the controllable element Output3 during State 2, Phase 1 at 1226 and 1227. The MSoO chart also shows that Output2 and Output3 should not be on at the same time.

We claim:

1. A system for verification and validation of device sequencing, comprising:
a data processor hosting a software tool where a software tool is active within said data processor;
the software tool receiving a sequence of operation (SoO) for a particular device, where the SoO defines the control processes for control of said particular device by an Industrial Control System(s) (ICS);
said SoO further comprising event definitions and fault and alarm conditions specific to the accurate minimum functional equivalency operation of the particular device;
the software tool communicating to both the ICS and external systems and managing communications between the ICS and the external systems;
the software tool further comprising a library of stored version components that include mechanical device descriptions, electrical device descriptions, and automation sequence coding;
the software tool creating a SoO chart representing all conditions and relationships between sensors, memory values, and output values for all elements that are controlled by the ICS for the particular device;
the software tool performing all logical comparisons, declared events, and state changes present in said SoO chart to validate the device sequencing and operation prior to transmitting the validated device sequencing for all devices to the ICS.

2. The system of claim 1, where the SoO contains states and phases for machine operation, where the states and phases articulate the functions of a machine and the machine operation.

3. The system of claim 2, where the SoO contains events, values of memory elements, inputs, and outputs describing the specific values that are related to controllable elements of the particular device.

4. The system of claim 1, further comprising a tag and object editor used by a human process designer to define the tags and objects associated with a control program to perform operations defined in said SoO.

5. The system of claim 4, where said tags and objects are presented as visual representation of controllable elements within the SoO.

6. The system of claim 1, further comprising the software tool receiving a Misuse Sequence of Operations (MSoO) comprising event definitions and fault and alarm conditions specific to the inaccurate or misuse of operations of the particular device.

7. The system of claim 1, where the software tool accurately documents the SoO and boundary conditions of the electrical and physical devices comprising the machine that are required to validate the control processes have been written to achieve the SoO.

8. The system of claim 6, where the software tool accurately documents the MSoO and boundary conditions of the electrical and physical devices comprising the machine that are required to protect against the mechanical failure or other dangerous conditions described in the MSoO and enforce documented boundary conditions for the machine.

9. The system of claim 1, where the SoO is constructed of controllable elements, such as outputs, timers, counters, and other operations, events, machine states and machine phases, controllable element values, and alarm conditions that cause a change in a state or phase for the machine.

10. The system of claim 4, where a tag comprises the declaration of a variable within an automation process.

11. The system of claim 4, where an object is an entity that encapsulates data and programming methods associated with the object.

12. The system of claim 1, further comprising a Sequence Design Tool component describing a protocol developed by an ICS vendor to define events and the sequence of those events required to verify and validate the operation of a machine supporting said protocol.

13. The system of claim 12, further comprising a Sequence of Events (SoE) editor function within said Sequence Design Tool permitting a user to describe tag values and the tag relationship to a simple or complex event to be used in verifying and validating the SoO for a machine.

14. The system of claim 6, further comprising all conditions and relationships between input sensors, memory value, and output values to the controllable elements that should not exist, or present a danger to machine operation or human use of a machine.
